(19) United States
(12) Patent Application Publication
(10) Pub. No.: US 2026/0141652 A1
(43) Pub. Date: May 21, 2026

(54) DIGITAL TWIN WITH REAL-TIME FEEDBACK AND REPRESENTATION OF REAL-LIFE SYSTEMS WITH MIXED REALITY

(71) Applicant: CreateASoft, Inc., Aurora, IL (US)

(72) Inventor: Hosni I. Adra, Naperville, IL (US)

(21) Appl. No.: 19/397,125

(22) Filed: Nov. 21, 2025

Related U.S. Application Data
(60) Provisional application No. 63/723,353, filed on Nov. 21, 2024.

(51) Int. Cl. G06T 19/00; G06N 20/00; G06T 7/70

(52) U.S. Cl. CPC G06T 19/006; G06N 20/00; G06T 7/70

(57) ABSTRACT

A facility for generating and using a digital twin to represent a structure, such as a complex or machine, via mixed reality is described herein. The facility accesses a digital twin simulation model including data indicating a current state of one or more aspects of a structure. The facility receives image data associated with the one or more aspects of the structure that indicates a real-world representation of the one or more aspects of the structure. The facility causes a mixed reality device to present a mixed reality user interface based on the digital twin simulation model and the image data. The mixed reality user interface includes the received image data and a visual representation of the data indicating the current state of one or more aspects of the structure overlayed onto the received image data.

### CROSS-REFERENCE TO RELATED APPLICATION(S)

This Application claims the benefit of Provisional Patent Application No. 63/723,353, filed Nov. 21, 2024, and entitled “DIGITAL TWIN WITH REAL-TIME FEEDBACK AND REPRESENTATION OF REAL-LIFE SYSTEMS WITH MIXED REALITY,” which is hereby incorporated by reference in its entirety.

In cases where the present application conflicts with a document incorporated by reference, the present application controls.

### BACKGROUND

Digital twin technology is used to generate more accurate models and true-to-life representations of the movement and activities of the real world. A digital twin may provide a representation of a structure such as a complex or a machine. The digital twin may represent actions and activities of the structure, material flowing through the structure, actions or activities performed within the structure, other activity that occurs relative to the structure, or some combination thereof.

### BRIEF DESCRIPTION OF THE DRAWINGS

FIG. 1 is a block diagram showing some of the components typically incorporated in at least some of the computer systems and other devices on which the facility operates.

FIG. 2 is a diagram of a sample environment in which the facility operates.

FIG. 3 is a flow diagram of a sample process to present a digital twin model of a structure, used by the facility in some embodiments.

FIG. 4 is a flow diagram of a sample process to present feedback regarding an interaction with an aspect of a structure, used by the facility in some embodiments.

FIG. 5 is a flow diagram of a sample process to present instructions regarding a repair of an aspect of a structure, used by the facility in some embodiments.

FIG. 6 is a flow diagram of a sample process to use a virtual model of a structure to display the effect of an interaction with an aspect of a structure, used by the facility in some embodiments.

### DETAILED DESCRIPTION

The inventors have recognized disadvantages of conventional digital twin technology, including the following. Conventional digital twin technology is not able to display information represented by a digital twin of a structure, such as a complex or a machine, in a physical area within the structure without the use of display screens placed in areas within the structure. Furthermore, conventional systems are unable to accurately display the effect of changes made to the structure, such as, in the context of a complex, changing where equipment is located, paths of entities, areas of activity for entities, the types of activities performed in the complex, changing other aspects of the complex, or some combination thereof, because conventional systems must display those changes on top of a video or image representation of the complex. Additionally, conventional systems are unable to accurately display how a structure reacts to input, and instead typically only display an output or outcome of the input. Accordingly, users of conventional systems are unable to accurately assess the state of the structure and effect of changes to the complex in “real-time.”

In response to recognizing these disadvantages, the inventors have conceived and reduced to practice a software and/or hardware facility for generating and using a digital twin to represent a structure, such as a complex or machine, via mixed reality (“the facility”). The facility uses mixed reality to display a representation of a model of a structure within, or on top of, the real-world version of a complex, machine, or other type of structure, and thus merges the “real-world” and “virtual-world” (e.g. the digital twin representation of the complex or machine) versions of the structure within a single view. The facility presents data that represents a state of the real-world structure to the viewer based on the point of view of the viewer. While the description below refers to the facility performing operations with respect to a complex or machine, embodiments are not so limited, and the facility may perform the operations with respect to a complex, machine, or any other type of structure.

For example, if the structure is a real-life warehouse, the facility uses a digital twin model of the warehouse to obtain data associated with the warehouse and aspects of the warehouse. The facility generates a mixed reality user interface based on image data of the real-life warehouse and the data associated with the warehouse and aspects of the warehouse. The facility uses one or more anchors identified in the image data to determine where in the mixed reality user interface to place data associated with the warehouse and aspects of the warehouse. The data associated with the warehouse and aspects of the warehouse may be data regarding the status of machines, robots, items, entities, etc., in the warehouse; data regarding paths taken by entities in the warehouse; data regarding past, present, or future state of a machine, robot, entity, item, etc., in the warehouse; or other data associated with the warehouse or aspects of the warehouse. The data may be placed or presented via text boxes, changing colors of aspects of the warehouse, symbols, etc. The data may be overlayed onto the image data such that the mixed reality user interface allows the user to see the real-life version of the warehouse and the data associated with the aspects of the warehouse at the same time. For example, the mixed reality interface may include a text box over an AGV detected in the image data that indicates the AGV's current load, destination, and starting point. The mixed reality user interface may also include a projected path of the AGV overlayed onto the image data such that it corresponds to the AGV's actual path as it moves through the warehouse.

In another example, if the structure is a real-life machine, the facility uses a digital twin model of the machine, or a digital twin model of a complex within which the machine is located, to obtain data associated with the machine and aspects of the machine. The facility generates a mixed reality user interface based on image data of the machine and the data associated with the machine and aspects of the machine. The facility uses one or more anchors identified in the image data to determine where in the mixed reality user interface to place data associated with the machine and aspects of the machine. The data may be displayed similarly to the display of the data with respect of the warehouse. For example, for a CNC machine the mixed reality user interface may include a text box over components of the CNC machine indicating what each component is and its status. The mixed reality user interface may also include colors overlayed onto components of the machine to indicate the status of those components, such as heat, wear, age, etc. The mixed reality user interface may also include symbols to indicate to a user where to interact with the machine, such as by displaying arrows pointing to a component, circles around a component, etc.

Mixed reality refers to one or more of: augmented reality, extended reality, conventional definitions of mixed reality, other methods of displaying data on top of a depiction of the real-world, or some combination thereof. Conventional methods of using or displaying mixed reality may refer to a live direct or indirect view of a physical, real-world environment whose elements are augmented by computer-generated sensory input, such as sound, graphics, labels, three-dimensional models, two-dimensional models, other methods of displaying or interacting with data, or some combination thereof. Augmented reality may include the overlaying of digital content, such as data, models, labels, graphics, etc., onto real-world objects, environments, or some combination thereof. Extended reality may include the enhancement, replacement, mirroring, etc., of the real-world with digital, or “virtual,” world content.

The facility maps a digital twin representation of a complex, such as a simulation model of the complex, to the real-world complex based on positional anchors. In some embodiments, the positional anchors are identified by the user, the digital twin representation, the real-world complex, or some combination thereof. In some embodiments, the anchors include a location of a mixed-reality user device, a direction that the mixed-reality user device faces, one or more symbols placed within the complex, one or more structural aspects of the complex (such as structural supports, pipes, wires, conduits, other structural aspects of a complex, etc.), one or more aspects of the complex (such as machines, entities, equipment, other aspects of the complex, etc.), or a combination thereof. In some embodiments, the number of anchors varies based on the type of digital twin representation, the complex being modeled, other factors for placing positional anchors within a complex, or some combination thereof. In some embodiments, the facility uses the anchors to identify an initial position of the viewer with respect to the real-world complex. In some embodiments, the facility utilizes a spatial representation of one or more entities included in the digital twin representation, a location of the viewer within the real-world, the activity of one or more entities within the complex, motion of entities within the complex, a state of one or more entities within the real-world complex, or some combination thereof, to generate visual data. The facility may display the visual data such that it appears to be overlaid on top of a live view of the complex.

In some embodiments, the facility uses a digital twin simulation model to simulate and analyze a live system. The facility simulates the operations of a complex that is modeled by the digital twin simulation model by connecting to one or more simulated data systems, actual data systems, other data systems, or some combination thereof. In some embodiments, the facility uses the digital twin simulation model to provide a way for the user to train on the digital twin simulation model instead of the real-life model. In such embodiments, the facility provides the user with the ability to change one or more aspects of the digital twin simulation model without changing aspects of the systems of the real-life complex and also be presented with and/or respond to changes not present in the real-life complex.

The facility determines how a structure will change, operate, move, or otherwise react to input or manipulation by a user. In some embodiments, the facility determines one or more outputs of the structure based on the input or manipulation by the user. In some embodiments, the facility determines how a structure will change, operate, move, or otherwise react to input or manipulation by a user by using an artificial intelligence or machine learning model trained to generate a prediction of how the structure will react to input or manipulation by a user. In some embodiments, the artificial intelligence or machine learning model is refined based on data received from a real-world version of the structure indicating how the structure reacts to input or manipulation by a user, such as by re-training the artificial intelligence or machine learning model. In some embodiments, the facility causes visual feedback to be displayed to a user via a mixed-reality user interface in response to the determination of how the structure will change, operate, move, or otherwise react to input or manipulation by a user.

By performing in some or all of the ways described above, the facility makes it easier for a person located within a complex to more fully understand its past, present, and/or future operation. Also, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, by determining how a structure will react to user input or manipulation and displaying a virtual-reality version of the structure, the facility may be used to train users in the proper operation of the structure without the structure being physically present. By allowing users to train on a virtual-reality version of the structure, computing and other resources, such as memory, processing power, other resources used by a structure, etc., of the real-world version of the structure are preserved for use by users already trained in its use, and the real-world version of the structure can be used for purposes other than training new users.

Further, for at least some of the domains and scenarios discussed herein, the processes described herein as being performed automatically by a computing system cannot practically be performed in the human mind, for reasons that include that the starting data, intermediate state(s), and ending data are too voluminous and/or poorly organized for human access and processing, and/or are a form not perceivable and/or expressible by the human mind; the involved data manipulation operations and/or subprocesses are too complex, and/or too different from typical human mental operations; required response times are too short to be satisfied by human performance; etc.

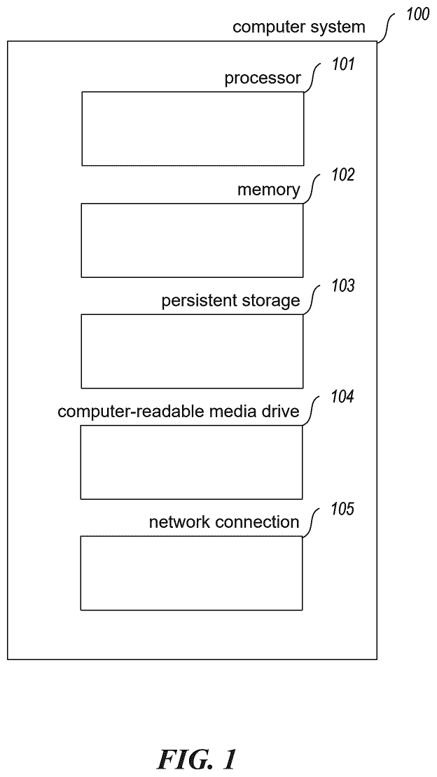

FIG. 1 is a block diagram showing some of the components typically incorporated in at least some of the computer systems and other devices on which the facility operates. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 101 for executing computer programs and/or training or applying machine learning models, such as a CPU, GPU, TPU, NNP, FPGA, or ASIC; a computer memory 102 for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. None of the components shown in FIG. 1 and discussed above constitutes a transitory propagating data signal per se. While computer systems configured as described above are typically used to support the operation of the facility, those skilled in the art will appreciate that the facility may be implemented using devices of various types and configurations, and having various components.

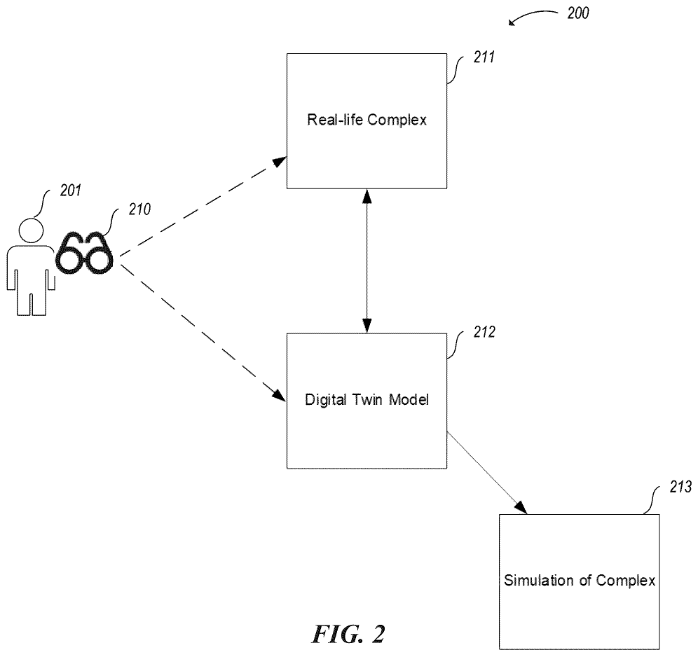

FIG. 2 is a diagram of a sample environment 200 in which the facility operates. The environment 200 includes a user 201; a mixed reality device 210 worn, carried, or otherwise used by the user 201; a real-life complex 211; a digital twin model 212; and a simulation of the complex 213. The mixed reality device 210 is a mixed reality, virtual reality, or augmented reality device configured to display a visual representations of data merged with an image of a real-world structure. The mixed reality device 210 may be a mixed reality headset, mixed reality glasses, a mobile device, a table computer, a computing device, other devices configured to display an augmented realty user interface, or some combination thereof. For example, the mixed reality device 210 may be virtual reality glasses or a virtual reality headset, such as Oculus, Meta Quest, XReal AR glasses, a smartphone, a tablet computer, or other virtual or mixed reality devices. In some embodiments, the mixed reality device 210 includes a location module configured to identify a location of the mixed reality device 210, such as via GPS, a compass, other location identification systems or devices, or a combination thereof.

In FIG. 2, the user 201 observes the real-life complex, digital twin model, or some combination thereof, via the use of the mixed reality device 210, as indicated by the dashed-lines. The mixed reality device 210 presents a virtual representation of data received from the digital twin model 212 over image data depicting aspects of the real-life complex 211. In some embodiments, the view observed by the user 201 is streamed to one or more viewing devices associated with one or more other users via a network connection of the facility, a mixed reality apparatus used by the user, a computing device associated with the user, or some combination thereof. The viewing devices may be mixed reality apparatuses, computing devices, other devices or systems capable of presenting data to users, or some combination thereof. In some embodiments, the view presented via a plurality of viewing devices are synchronized, such as to provide the same representation of the complex to one or more viewers. The devices may be interactive devices that allow a user to interact with the digital twin model, passive “viewing-only” type devices that do not allow a user to interact with the digital twin model, or some combination thereof.

The real-life complex 211 is a real-life version of the complex that the user observes. In some embodiments, the real-life complex 211 is a real-life structure. In such embodiments, the real-life complex 211 may be a machine, a complex, or another type of structure. Aspects of the real-life complex 211 may be associated with one or more data sources such as WMS, ERP, PLC, IoT devices, other data sources, or some combination thereof. The aspects of the real-life complex 211 transmit data to the data sources for use by the digital twin model 212.

In some embodiments, the real-life complex 211 is a warehouse or other type of complex. In such embodiments, the mixed reality interface presents information associated with one or more aspects of the warehouse, including one or more moving entities, one or more stationary entities, or some combination thereof. The information may include, but is not limited to, the status of one or more entities, performance metrics associated with one or more entities, historical performance of one or more entities, one or more future activities scheduled to be performed by one or more entities, one or more future activities predicted to be performed by one or more entities, entity information for one or more entities, traceability, visual cues associated with one or more entities, other information associated with one or more entities or components of the warehouse, or some combination thereof. In some embodiments, traceability information includes information associated with one or more instances or sequences of movement, touches, other interactions, or some combination thereof, of, or with, an entity or item associated with the complex. In some embodiments, the traceability information includes an aggregation of the interactions of, or with, an entity or item associated with the complex, a duration of the interactions, and an outcome of at least one or more of the interactions. In some embodiments, the information for an entity or item, such as the traceability information, status information, performance information, activity information, etc., may be different between a simulation of the complex generated based on the digital twin model and the real-life complex. In such embodiments, the facility may present these differences in information for an entity or item via the mixed reality user interface.

The digital twin model 212 may be a digital twin simulation model that is used to simulate and analyze the real-life complex 211. The facility uses the digital twin model to record a current or past state of the real-life complex and its components, and to simulate a future state of the real-life complex 211 and its components. The facility may also apply changes made to the digital twin model 212 to the real-life complex 211, or vice versa, based on the states of the real-life complex 211 and digital twin model 212. The digital twin model 212, any simulations of the complex 211 produced by the digital twin model 212, or some combination thereof, are data representations of the current state of the real-life complex 211, predicted future states of the real-life complex 211, possible future states of the real-life complex 211, past states of the real-life complex 211, etc. Such data representations may be considered a “virtual-world” version of the real-life complex 211 that the user is able to view via a display, mixed reality device 210, or some combination thereof. In some embodiments, the facility represents changes to the digital twin model 212 based on the data sources that receive data from aspects of the real-life complex 211, user interaction with the digital twin model 212, user interaction with the real-life complex 211, or some combination thereof.

The facility generates a simulation of the complex 213 by simulating the operations of the real-life complex 211 that is modeled by the digital twin model 212 by connecting to one or more simulated data systems, actual data systems, other data systems, or some combination thereof. In some embodiments, the facility uses the digital twin model 212 to provide a way for the user to train on the digital twin simulation model 212 instead of the real-life complex 211. In such embodiments, the facility provides the user with the ability to change one or more aspects of the digital twin model 212 without changing aspects of the systems of the real-life complex 211 and also be presented with and/or respond to changes not present in the real-life complex 211.

In some embodiments, the facility uses the digital twin model 212 to predict an outcome, or “future state,” of the real-life complex 211 based on one or more states that represent the current state, historical performance, processed items, schedules, maintenance cycles, devices with which a user or entity has interacted, other internal or external states of the complex or aspects of the complex, or some combination thereof. In such embodiments, the outcome or future state of the real-life complex 211 may include one or more reactions of the real-life complex 211 to input, manipulation, or other types of interactions with aspects of the real-life complex 211.

In some embodiments, the facility generates the simulation of the complex 213 by using one or more artificial intelligence or machine learning models. In such embodiments, the artificial intelligence or machine learning models are trained by using data indicating how the real-life complex 211 reacts to inputs to, manipulations of, or other interactions with, the real-life complex 211. In some such embodiments, data regarding the reaction of the real-life complex 211 to interactions is collected by using the digital twin model 212 and the data generated by aspects of the real-life complex 211. In such embodiments, the data regarding the reaction of the real-life complex 211 to interactions is used to refine, or re-train, the one or more artificial intelligence or machine learning models.

The facility maps a digital twin representation of a complex, such as a simulation model of the complex, to the real-world complex based on one or more positional anchors. In some embodiments, the positional anchors are identified by the user, the digital twin representation, the real-world complex, or some combination thereof. In some embodiments, the number of anchors varies based on the type of digital twin representation, the complex being modeled, other factors for placing positional anchors within a complex, or some combination thereof. In some embodiments, the facility uses the anchors to identify an initial position of the viewer with respect to the real-world complex. In some embodiments, the facility utilizes a spatial representation of one or more entities included in the digital twin representation, a location of the viewer within the real-world, the activity of one or more entities within the complex, motion of entities within the complex, a state of one or more entities within the real-world complex, or some combination thereof, to generate visual data. The facility may use the mapping of the digital twin representation of the complex to display the visual data such that it appears to be overlaid on top of a live view of the complex.

In some embodiments, the digital twin model includes equipment, a piece of equipment, an extended automation line, other components of the complex, or some combination thereof, that are displayed by the facility via mixed reality over the real-world version of the complex. In some embodiments, the facility uses the mixed reality display to provide visual feedback on the status of the components of the complex, such as equipment, a piece of equipment, an extended automation line, etc. In some embodiments, the visual feedback includes an indication of a status of a component of the complex; an error, defect, or other fault of a component of the complex; a remedy to a fault of a component of the complex; a change for one or more components of the complex based on a status of a component of the complex; instructions to remedy a fault in a component of a complex; other information related to a component of a complex; or some combination thereof.

For example, in the case of a heated motor, the facility may cause the representation of the motor included in the digital twin model to change color to indicate a heat signature of the motor to the viewer. In such an example, the facility may use the digital twin model 212 to identify one or more causes of the current heat signature of the motor and may display visual feedback to the user via the mixed reality device 210 based on the identified causes. In some embodiments, the facility recommends one or more remedies to a cause of the heat signature of the motor. In some embodiments, the facility presents instructions to a user via the mixed reality interface to modify, repair, or otherwise change an aspect of the motor related to the cause of the heat signature of the motor.

In another example, the real-life complex includes a machine that performs an operation on parts flowing in the complex. The facility may generate data indicating how the machine is operating, actual cycle times, error rates, other data associated with the machine, or some combination thereof. In some embodiments, the facility presents the data via the mixed reality device 210. For example, the facility may provide a visual representation of data points where heat is depicted as a color spectrum, and may display the data points where one or more of the machine motors are located. In some embodiments, the visual representation includes one or more visual cues that aid the viewer in identifying the status of parts of the machine.

In some embodiments, the facility provides the digital twin model 212 to a user for training purposes via the mixed reality device 210. In such embodiments, the facility may use the digital twin model 212 to provide both the virtual and real-life activities of the complex being modeled. For example, the mixed reality user interface may present an indication of data generated as a result of the operations of components of the complex in a manner that associates the generated data with the components for which the data is generated. In some embodiments, when the digital twin model is provided for training purposes, the facility does not apply changes to the digital twin model 212 to the real-life complex 211.

In some embodiments, the facility includes one or more artificial intelligence or machine learning models that output one or more potential outcomes to one or more actions performed by a user or system, such as the artificial intelligence or machine learning models described above with respect to the generation of the simulation of the complex 213. The artificial intelligence or machine learning models may receive an indication of one or more actions performed by a user, a remote viewer, a system associated with the complex, or some combination thereof. In some embodiments, the facility presents a depiction of one or more potential outcome to one or more display devices configured to display the digital twin model via mixed reality. In some embodiments, multiple potential outcomes may be presented to a user. In some embodiments, the facility enables a user to view any number of the multiple potential outcomes via the same viewing apparatus.

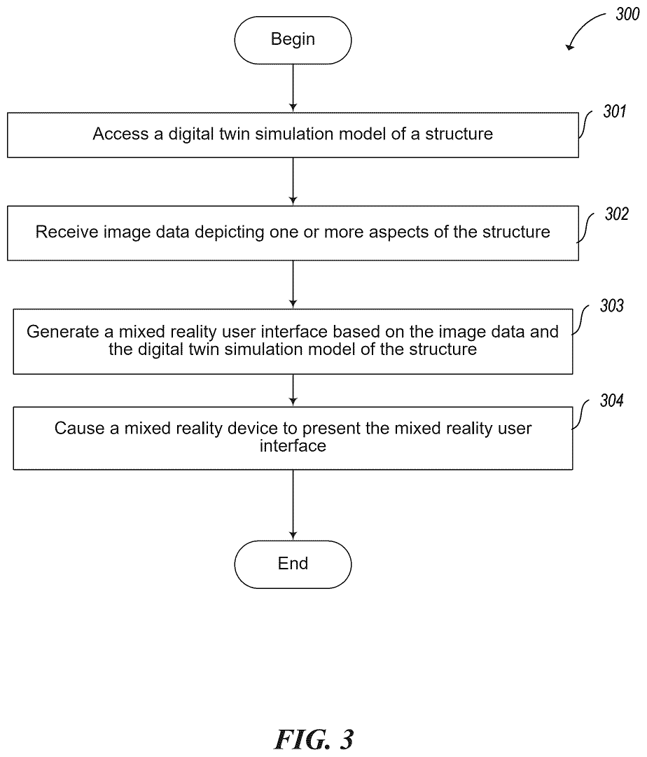

FIG. 3 is a flow diagram of a sample process 300 to present a digital twin model of a structure, used by the facility in some embodiments.

At act 301, the facility accesses a digital twin simulation model of a structure, such as the digital twin model 212 described above in connection with FIG. 2.

At act 302, the facility receives image data depicting one or more aspects of the structure. In some embodiments, the image data is received from a mixed reality device, such as the mixed reality device 210 described above in connection with FIG. 2. In some embodiments, at act 302, the facility receives location data from the mixed reality device 210.

At act 303, the facility generates a mixed reality user interface based on the data received in act 302 and the digital twin simulation model of the structure. In some embodiments, the mixed reality user interface includes a visual representation of data received in act 302, data used by the digital twin simulation model accessed at act 301, other data, or a combination thereof. In some embodiments, the visual representation of data includes a visual representation of data regarding the status of one or more aspects of the structure, information relevant to a user's role with respect to the structure, predictions of reactions or future states of the structure, one or more past statues of the structure, other data associated with a structure, or a combination thereof.

For example, the mixed reality user interface may display text above an aspect of the structure regarding the status of the aspect of the structure, past states of the structure, predicted future states of the structure, etc. In another example, the mixed reality user interface may change the color of one or more aspects of a structure based on the data associated with the structure, such as changing the color of a part of a machine to indicate heat, to indicate that a user is to interact with a part of a machine, etc. In another example, the mixed reality user interface includes instructions for a user's interaction with an aspect of a structure, such as instructions for how to use the aspect of the structure, how to fix the aspect of the structure, a location of an aspect of a structure that may not be in the user's view, etc. In another example, the mixed reality user interface includes a virtual representation of a structure or aspect of a structure. In such an example, the facility may change, manipulate, animate, etc., the virtual representation of the structure or aspect of the structure to reflect the reaction of the structure or aspect of the structure to an interaction.

At act 304, the facility causes a mixed reality device, such as the mixed reality device 210 described above in connection with FIG. 2, to present the mixed reality user interface.

After act 304, the process 300 ends.

Those skilled in the art will appreciate that the acts shown in FIG. 3 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

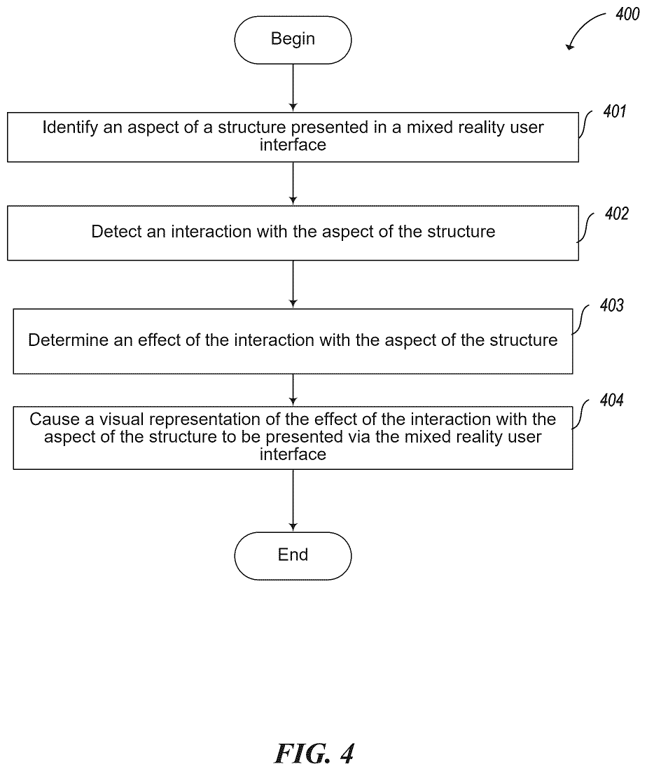

FIG. 4 is a flow diagram of a sample process 400 to present feedback regarding an interaction with an aspect of a structure, used by the facility in some embodiments.

At act 401, the facility identifies an aspect of a structure presented in a mixed reality user interface. In some embodiments, the aspect of the structure is identified based on data from a digital twin model 211 and one or more anchors. For example, the facility may identify an automated guided vehicle (“AGV”) depicted in image data based on a location of the mixed reality device, an identifier of the AGV visible in image data, data indicating where the AGV is currently located included in the digital twin model, other anchor data, or a combination thereof. As another example, the facility may identify one or more controls of a computer numerical control (“CNC”) machine based on a location of the mixed reality device, aspects of the CNC machine visible in image data, data from a digital twin model indicating one or more controls of the CNC machine that have been interacted with, other anchor data, or a combination thereof.

At act 402, the facility detects an interaction with the aspect of the structure. In some embodiments, the interaction with the aspect of the structure may be an interaction with the real-life structure, a digital twin model of the structure, or a combination thereof. In some embodiments, an interaction with an aspect of a complex includes the receipt of items, shipping items out, changing the placement of aspects of the complex, changing a number of entities present in the complex, changing the location of areas in the complex, changing the operation of an entity in the complex, changing future orders to ship items, changing future orders to receive items, other interactions with an aspect of a complex, or a combination thereof. In some embodiments, an interaction with an aspect of a machine includes providing input to the machine by a user or another machine, an interaction with a control of the machine, adding a component to the machine, removing a component of the machine, changing a component of the machine, other interactions with an aspect of a machine, or a combination thereof.

At act 403, the facility determines an effect of the interaction with the aspect of the structure. In some embodiments, the facility uses a digital twin model, a simulation model, an artificial intelligence or machine learning model trained to predict a reaction of the machine to the interaction, or a combination thereof, to determine the effect of the interaction with the aspect of the structure.

For example, when the structure is a complex, the aspect of the structure is an AGV, and the change is a change to the placement of one or more shelves within the complex, the facility may determine a new path for the AGV. In another similar example, if the interaction is a change to a future order in which the future order will have items of a different type than previously indicated, the facility may determine locations within the complex where the AGV is likely to experience more traffic than it would have experienced before the future order was changed. In another example, when the structure is a machine, such as a CNC machine, and the interaction results in the receipt of instructions for operation of the CNC machine, the facility determines how the components of the CNC machine will react to the instructions and what the final output would be. In another example, the interaction may be an input to the CNC machine via a control (e.g. a button, knob, lever, or other control) of the CNC machine while the CNC machine is following a set of instructions, and the facility may determine how the components of the CNC machine respond to receiving the input via the control. In each of these examples, the facility may receive data from the digital twin model that indicates the interaction and apply a simulation model, artificial intelligence model, or machine learning model to the data indicating the interaction to determine the effect of the interaction with the aspect of the structure.

At act 404, the facility causes a visual representation of the effect of the interaction with the aspect of the structure to be presented via the mixed reality interface. In some embodiments, the facility performs act 404 in a similar manner to performing acts 303 and 304, described above in connection with the process 300.

After act 404, the process 400 ends.

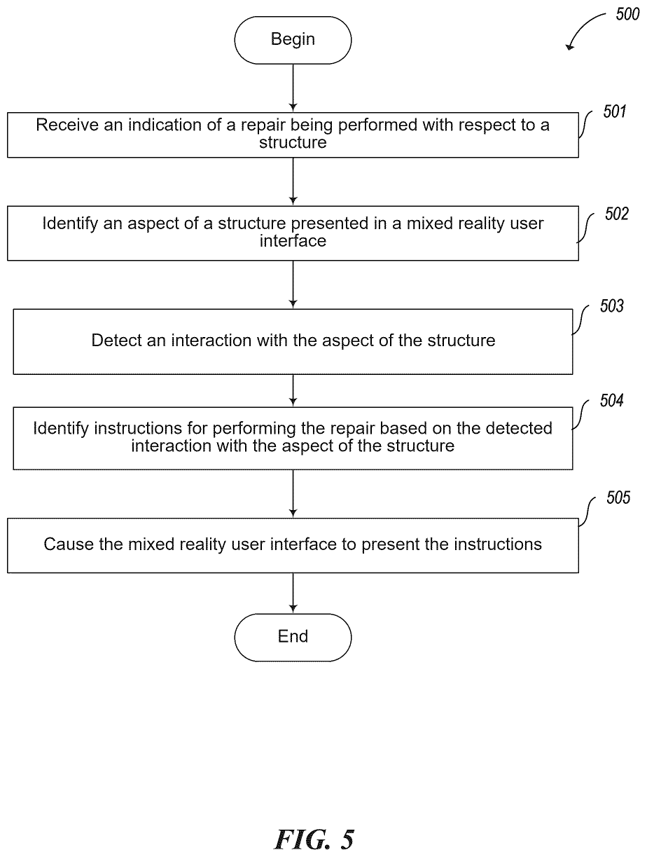

FIG. 5 is a flow diagram of a sample process 500 to present instructions regarding a repair of an aspect of a structure, used by the facility in some embodiments.

At act 501, the facility receives an indication of a repair being performed with respect to a structure. In some embodiments, the facility receives the indication of the repair via user input. In some embodiments, the facility accesses instructions for performing the repair based on the indication of the repair performed with respect to the structure.

At act 502, the facility identifies an aspect of a structure presented in a mixed reality user interface. In some embodiments, the facility identifies the aspect of the structure based on image data received from a mixed reality device. In some embodiments, the structure being repaired is a virtual representation of the structure presented via the mixed reality user interface. In such embodiments, the facility identifies the aspect of the structure based on a user interaction with the virtual representation of the structure detected by the mixed reality device.

At act 503, the facility detects an interaction with the aspect of the structure. In some embodiments, the interaction with the aspect of the structure includes a change, addition, removal, or other manipulation of the aspect of the structure. In some embodiments, the interaction is detected based on image data received from the mixed reality device, data received form a digital twin model indicating the interaction with the device, or a combination thereof. For example, the interaction may be the disconnection or reconnection of a component of the structure. In such an example, the image data may indicate that a component of the structure was disconnected or reconnected; the digital twin model may receive data from the real-life structure indicating that the component was disconnected or reconnected; etc.

At act 504, the facility identifies instructions for performing the repair based on the detected interaction with the aspect of the structure. In some embodiments, the facility identifies the instructions for performing the repair by identifying a previously executed instruction based on the detected interaction, and selecting the next instruction in the set of instructions. For example, a user may be replacing a mill of a CNC machine with a different mill. In such an example, when the instructions for disconnecting the old mill are executed, the facility identifies the instructions for installing the new mill.

At act 505, the facility causes the mixed reality user interface to present the instructions. In some embodiments, the facility performs act 505 in a similar manner to performing acts 303 and 304, described above in connection with the process 300.

After act 505, the process 500 ends. In some embodiments, the process 500 is performed with respect to the training of a user in the user of a structure. In such embodiments, instead of repair instructions, the instructions are instructions regarding how the user is to use the structure to perform a selected task.

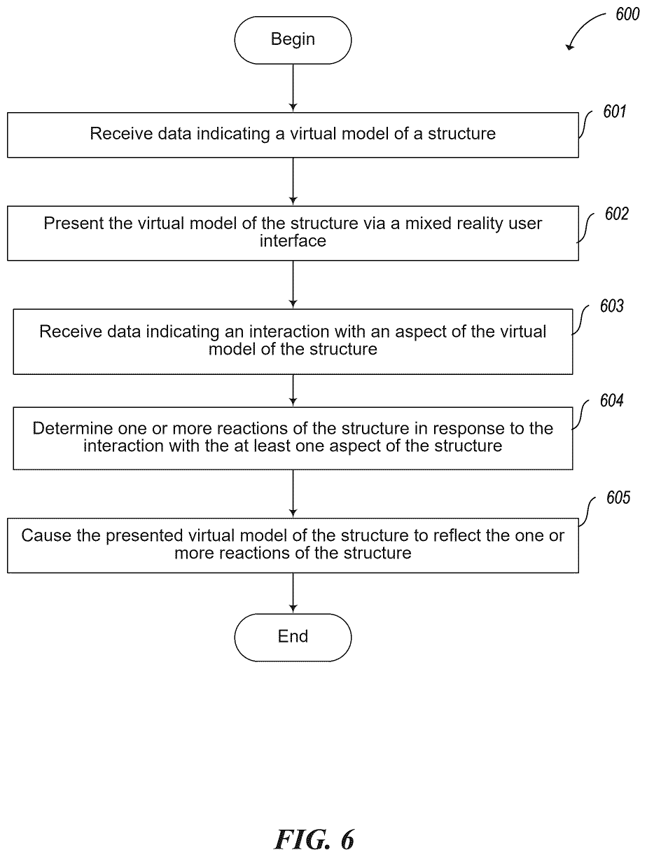

FIG. 6 is a flow diagram of a sample process 600 to use a virtual model of a structure to display the effect of an interaction with an aspect of a structure, used by the facility in some embodiments.

At act 601, the facility receives data indicating a virtual model of a structure. In some embodiments, the data indicating the virtual model is data that is able to be used to generate a multi-dimensional depiction of the structure. For example, the data may be computer aided design (“CAD”) data that represents the structure and its components.

At act 602, the facility presents the virtual model of the structure via a mixed reality user interface. In some embodiments, the mixed reality user interface presents the depiction of the structure overlayed onto an image of the user's surroundings.

At act 603, the facility receives data indicating an interaction with an aspect of the virtual model of the structure. In some embodiments, the data indicating an interaction is data received from a mixed reality device indicating the user's interaction with the virtual model of the structure. In some embodiments, the data indicating an interaction is data that simulates an interaction with a structure, such as instructions input into a computing device that would transmit the instructions to the structure. For example, the instructions may be instructions for a CNC machine that are input by a user at a computing device that would ordinarily transmit the instructions to a real-life CNC machine. In such an example, the computing device may transmit the instructions to the facility instead of a real-life CNC machine.

At act 604, the facility determines one or more reactions of the structure in response to the interaction with the at least one aspect of the structure. The reactions of the structure may include how one or more components of the structure move, change, or are otherwise manipulated by the structure in response to the interaction; an output of the structure in response to the interaction; other reactions of the structure or its components in response to the interaction; or a combination thereof. For example, if the structure is a CNC machine, the reactions may include how the spindle, worktable, mill, or other components of the CNC machine move in order to execute instructions received by the CNC machine for milling a piece of material. In another example, if the structure is a complex, the reactions may include how the behavior of one or more entities change in response to the interaction.

In some embodiments, the one or more reactions are determined by applying an artificial intelligence or machine learning model to the data indicating the interaction. In such embodiments, the artificial intelligence or machine learning model is trained to predict one or more reactions of the structure to the interaction. In some embodiments, the artificial intelligence or machine learning model is trained by using data collected from real-life versions of the structure. In some embodiments, the training data includes data indicating interactions with the structure and one or more reactions of the structure or its components that are collected by using a digital twin model. In some embodiments, additional training data is collected by using the digital twin model. In such embodiments, the additional training data is used to refine, re-train, etc., the artificial intelligence or machine learning model. In some embodiments, the facility uses a plurality of artificial intelligence or machine learning models. In some such embodiments, each respective artificial intelligence or machine learning model is a model trained for a respective structure, such as a model trained for identifying reactions of a complex in response to interactions, a model trained for identifying reactions of a particular machine in response to interactions (e.g. a CNC machine, an AGV, etc.), etc.

At act 605, the facility causes the presented virtual model of the structure to reflect the one or more reactions of the structure. In some embodiments, reflecting the one or more reactions of the structure includes animating the presented virtual model of the structure based on the one or more reactions. For example, if the structure is a CNC machine, the presented virtual model may be animated to reflect how components of the CNC machine move in response to the received interactions. In another example, if the structure is a complex, one or more virtual representations of aspects of the complex, such as entities, objects, or other aspects of the complex, may be animated to reflect how the aspects of the complex will move, change, operate, etc., in response to the received interactions.

After act 605, the process 600 ends.

In some embodiments, the process 600 is used to train one or more users on the operation of the structure. By presenting a virtual model of the structure, allowing users to interact with the virtual model of the structure, and accurately reflecting the reaction of the aspects or components of the structure in response to user interaction, the virtual model of the structure can be used to train a user in the operation of the structure without using a real-life version of the structure for training.

This patent application incorporates by reference: U.S. Non-Provisional patent application Ser. No. 18/525,419 , titled DYNAMIC SLOTTING, filed on Nov. 30, 2023; U.S. Non-Provisional patent application Ser. No. 18/482,712 , titled DYNAMIC PUT-AWAY, filed on Oct. 6, 2023; and U.S. Non-Provisional patent application Ser. No. 17/539,027 , titled TRANSITIONING SIMULATION ENTITIES BETWEEN SMART ENTITY STATUS AND DISCRETE ENTITY STATUS, filed on Nov. 30, 2021. In situations where the present document and any document incorporated by reference conflict, the present document controls.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
accessing a digital twin simulation model, the digital twin simulation model including data indicating a current state of one or more aspects of a complex;
receiving image data associated with the one or more aspects of the complex, the image data indicating a real-world representation of the one or more aspects of the complex;
causing a mixed reality device to present a mixed reality user interface based on the digital twin simulation model and the image data, the mixed reality user interface including:
the received image data; and
a visual representation of the data indicating the current state of the one or more aspects of the complex overlayed onto the received image data.

2. The method of claim 1, further comprising:
detecting a user's interaction with at least one aspect of the complex based on the received image data;
identifying instructions for further interaction with the at least one aspect of the complex based on the interaction with the at least one aspect of the complex; and
causing a visual representation of the instructions for further interaction with the at least one aspect of the complex to be overlayed onto the received image data.

3. The method of claim 1, wherein causing a mixed reality device to present the mixed reality user interface further comprises:
accessing data representing at least one aspect of the one or more aspects of the complex; and
causing a visual representation of the at least one aspect of the complex to be overlayed onto the received image data based on the data representing the at least one aspect of the complex.

4. The method of claim 3, further comprising:
receiving data indicating an interaction with the at least one aspect of the complex;
determining one or more effects of the interaction with the at least one aspect of the complex; and
causing the overlayed visual representation of the at least one aspect of the complex to be changed to indicate one or more effects of the interaction with the at least one aspect of the complex.

5. The method of claim 1, further comprising:
detecting a user's interaction with at least one aspect of the complex based on the received image data;
determining the effect of the interaction with the at least one aspect of the complex; and
causing a visual representation of the effect of the interaction with the at least one aspect of the complex to be overlayed onto the received image data.

6. The method of claim 1, further comprising:
receiving data indicating an interaction with at least one aspect of the complex;
selecting a machine learning model based on the at least one aspect of the complex, the machine learning model being trained to predict the reaction of the at least one aspect of the complex in response to an interaction; and
applying the machine learning model to the data indicating the interaction with at least one aspect of the complex to obtain a prediction of the reaction of the at least one aspect of the complex in response to the interaction.

7. The method of claim 1, wherein causing the mixed reality device to present the mixed reality user interface further comprises:
identifying a position of a device that captured the image data based on one or more of:
a symbol depicted in the image data;
a part of a structure depicted in the image data;
an entity depicted in the image data; and
a location of a device that captured the image data; and
overlaying the data indicating the current state of the one or more aspects of the complex based on the received image data and the identified one or more anchors.

8. A system comprising:
a computing device comprising memory and at least one processor configured to:
access a digital twin simulation model, the digital twin simulation model including data indicating a current state of one or more aspects of a machine;
receive image data associated with the one or more aspects of the machine, the image data indicating a real-world representation of the one or more aspects of the machine;
cause a mixed reality device to present a mixed reality user interface based on the digital twin simulation model and the image data, the mixed reality user interface comprising:
the received image data; and
a visual representation of the data indicating the current state of the one or more aspects of the machine overlayed onto the received image data.

9. The system of claim 8, wherein the computing device is further configured to:
detect a user's interaction with at least one aspect of the machine based on the received image data;
determine the effect of the interaction with the at least one aspect of the machine; and
cause a visual representation of the effect of the interaction with the at least one aspect of the machine to be overlayed onto the received image data.

10. The system of claim 8, wherein the computing device is further configured to:
receive data indicating an interaction with at least one aspect of the complex;
select a machine learning model based on the at least one aspect of the complex, the machine learning model being trained to predict the reaction of the at least one aspect of the complex in response to an interaction; and
apply the machine learning model to the data indicating the interaction with at least one aspect of the complex to obtain a prediction of the reaction of the at least one aspect of the complex in response to the interaction.

11. The system of claim 8, wherein the computing device is further configured to:
detect a user's interaction with at least one aspect of the machine based on the received image data;
identify instructions for further interaction with the at least one aspect of the machine based on the interaction with the at least one aspect of the complex; and
cause a visual representation of the instructions for further interaction with the at least one aspect of the machine to be overlayed onto the received image data.

12. The system of claim 8, wherein the computing device is further configured to:
access data representing how the machine looks; and
cause a visual representation of the machine to be overlayed onto the received image data based on the data representing how the machine looks.

13. The system of claim 12, wherein the computing device is further configured to:
receive data indicating an interaction with the at least one aspect of the machine;
determine one or more effects of the interaction with the at least one aspect of the machine; and
cause the overlayed visual representation of the at least one aspect of the machine to be changed to indicate one or more effects of the interaction with the at least one aspect of the machine.

14. The system of claim 8, wherein the computing device is further configured to:
identify a position of a device that captured the image data based on one or more of:
a symbol depicted in the image data;
a part of a structure depicted in the image data;
an entity depicted in the image data; and
a location of a device that captured the image data; and
overlay the data indicating the current state of the one or more aspects of the complex based on the received image data and the identified one or more anchors.

15. One or more instances of computer-readable media collectively having contents configured to cause a computing system to perform a method comprising:
accessing a digital twin simulation model, the digital twin simulation model including data indicating a state of one or more aspects of a structure;
receiving image data associated with the one or more aspects of the structure, the image data indicating a real-world representation of the one or more aspects of the structure;
causing a mixed reality device to present a mixed reality user interface based on the digital twin simulation model and the image data, the mixed reality user interface including:
the received image data; and
a visual representation of the data indicating a state of the one or more aspects of the structure overlayed onto the received image data.

16. The one or more instances of computer-readable media of claim 15, the method further comprising:
detecting a user's interaction with at least one aspect of the structure based on the received image data;
determining the effect of the interaction with the at least one aspect of the structure; and
causing a visual representation of the effect of the interaction with the at least one aspect of the structure to be overlayed onto the received image data.

17. The one or more instances of computer-readable media of claim 15, the method further comprising:
detecting a user's interaction with at least one aspect of the structure based on the received image data;
identifying instructions for further interaction with the at least one aspect of the structure based on the interaction with the at least one aspect of the structure; and
causing a visual representation of the instructions for further interaction with the at least one aspect of the structure to be overlayed onto the received image data.

18. The one or more instances of computer-readable media of claim 15, the method further comprising:
accessing data representing at least one aspect of the one or more aspects of the structure; and
causing a visual representation of the at least one aspect of the structure to be overlayed onto the received image data based on the data representing the at least one aspect of the structure.

19. The one or more instances of computer-readable media of claim 18, the method further comprising:
receiving data indicating an interaction with the at least one aspect of the structure;
determining one or more effects of the interaction with the at least one aspect of the structure; and
causing the overlayed visual representation of the at least one aspect of the structure to be changed to indicate one or more effects of the interaction with the at least one aspect of the structure.

20. The one or more instances of computer-readable media of claim 15, the method further comprising:
identifying a position of a device that captured the image data based on one or more of:
a symbol depicted in the image data;
a part of a structure depicted in the image data;
an entity depicted in the image data; and
a location of a device that captured the image data; and
overlaying the data indicating the current state of the one or more aspects of the structure based on the received image data and the identified one or more anchors.
